(19) United States
(12) Patent Application Publication
(10) Pub. No.: US 2015/0240550 A1
(43) Pub. Date: Aug. 27, 2015

(54) ADD-ON WINDOW INSULATION SYSTEM

(71) Applicant: Philip John CARTER, Mt Iron, Wanaka (NZ)

(72) Inventor: Philip John Carter, Wanaka (NZ)

(21) Appl. No.: 14/437,475

(22) PCT Filed: Nov. 8, 2013
(86) PCT No.: PCT/NZ2013/000200

§ 371 Date: Apr. 21, 2015

(30) Foreign Application Priority Data
Nov. 12, 2012 (NZ) 603552

(51) Int. Cl. E06B 3/263; E06B 3/56; E06B 3/28; E06B 3/673; E06B 3/677; E06B 3/54; E06B 3/66

(52) U.S. Cl. CPC E06B 3/263; E06B 3/5409; E06B 3/5454; E06B 3/56; E06B 3/66; E06B 3/67391; E06B 3/6775; E06B 3/285; E06B 2003/5463

(57) ABSTRACT

A glazing frame profile configuration (A) used to create an Add-on Window and Door insulation system comprising two layers of preferably transparent glazing panes. The profile configuration has a glazing section (1) followed by a spacer (3) followed by a glazing section (2) and then a second spacer (4). Each glazing section (1 and 2) provides an edge cover to the additional glazing; however the glazing profile configuration does not provide a frame to the existing window pane (B). A preferable method for mounting the add-on unit is to have a leg (12) on the end of the spacer (4) with a mounting tape C attaching it to the existing pane B.

This application is a 35 U.S.C. 371 national stage application of PCT Application No. PCT/NZ2013/000200, filed Nov. 8, 2013, which claims priority to NZ 603552, filed Nov. 12, 2012, each of which is hereby incorporated by reference in its entirety.

### TECHNICAL FIELD

The present application relates to an insulation add-on for existing windows and doors.

### BACKGROUND

Many homes have single or double glazed windows. The houses lose heat through the windows and in some cases through conductive metal joinery much more readily than the insulated walls, and are prone to condensation in winter. The present application seeks to provide an add-on system comprising two additional layers of transparent material that fits to existing window units, and is easily attached with little or no modification to the existing unit, and without removing the existing glass. The present application also seeks to provide the add-on system with the option of a low thermal conductivity border that will cover the existing joinery on either the inside or outside of the building in order to reduce condensation on the window frames.

The window insulation system described herein will add two layers of transparent material with a suitable cavity therebetween to the glass of existing window frames. Said window insulation system will have a unique edge carrier to hold the transparent material, and to facilitate easy and tidy fitting to the existing window unit, such that the existing pane and the add-on material will also have a suitable cavity therebetween. Said edge carrier should attach to the window frame or to the pane, and may create a seal between the add-on unit and the existing glass or frame. Said cavities may be filled with air, or other stable gases such as argon, or alternatively said cavities may contain a vacuum or be ventilated. Said edge carrier may be fitted to any existing window or door frames regardless of the existing construction material. Said window insulation system may be mounted either inside or outside the building. Said edge carrier may cover part of the window or door frame with preferably lower thermal conductivity material.

### BRIEF DESCRIPTION OF DRAWINGS

Further aspects of various embodiments described herein will become apparent from the ensuing description which is given by way of example only and with reference to the accompanying drawings in which FIGS. 1-12 show a profile view of various embodiments described herein.

FIGS. 1-12 show various embodiments of the glazing frame profile configuration indicated by arrow A, and an existing window pane indicated by arrow B. The profile configuration has a glazing section 1 followed by a spacer 3 followed by a glazing section 2 and then a second spacer 4. Each glazing section 1 and 2 provides an edge cover to the additional glazing material, however the glazing profile configuration does not provide a frame to the existing window pane (B).

FIG. 4 shows an additional leg 12 of the glazing frame profile configuration, which provides a simple and effective way to attach the add-on unit A to the existing window pane B using an adhesive section C.

FIG. 5 shows the glazing frame profile A in relation to an existing window frame E. The glazing frame A is easily positioned within the existing frame E, using a foam section D, and is attached to the glass with an adhesive C.

FIG. 6 shows an embodiment to use when the existing window pane B does not have a flat surface, such as obscure glass or a lead-light. The foam section D is attached to the glazing frame A, and is also attached to the existing window frame E via the adhesive C. The filled section G is preferably made of a silicon sealant or similar, which hides the mounting detail and seals the add-on unit A against the existing window frame E.

FIG. 7 shows the glazing frame profile configuration A with the addition of a leg 6, which is made of a material that will bend readily to assist the positioning of the glazing frame A within the existing window frame E. The leg 6 has an adhesive C to attach to the existing frame E. A flexible seal 5 presses against the existing pane B.

FIG. 8 shows the glazing frame A with an alternative box section spacer 3. The glazing frame A is held in position by flexible fins 7.

FIG. 9 shows the glazing frame profile configuration A with the addition of a leg 8, which covers part of the existing window frame E in order to enhance the overall appearance of the window unit and insulate the existing frame E as well as the existing glass B.

FIG. 10 shows an alternative attachment design for the glazing frame A, by using a pre-installed mounting section F.

FIG. 11 shows the glazing frame profile configuration A wherein the glazing section 2 has a flexible side 10 to allow tolerance in the glazing material thickness. The glazing section 1 has a flexible portion 9 that also extends to connect to the existing window frame E to allow ease of installation and tidy appearance.

FIG. 12 shows the glazing frame profile configuration A with the addition of glue channels 13 and 14 within the glazing sections 1 and 2. The leg 6 has flexible fins 11 attached to it, for the purpose of speeding up the installation of the glazing frame A, and also to make it easier to remove the glazing frame A, should the need arise.

### DETAILED DESCRIPTION

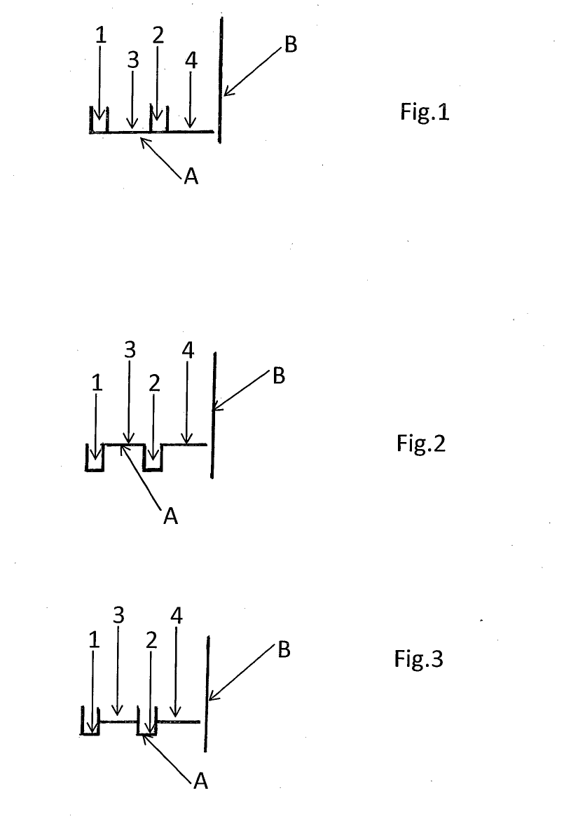

The glazing frame profile configuration of FIGS. 1-12 generally denoted by the arrow A comprises: 2 glazing sections (1&2) separated by a spacer 3. A second spacer 4 separates the existing pane B from the added glazing material in glazing section 2 of glazing frame A. FIGS. 1-3 show the profile configuration with the spacer material in three different embodiments described herein. The glazing frame is preferably made of low thermal conductivity material such as plastic, and is preferably formed through extrusion.

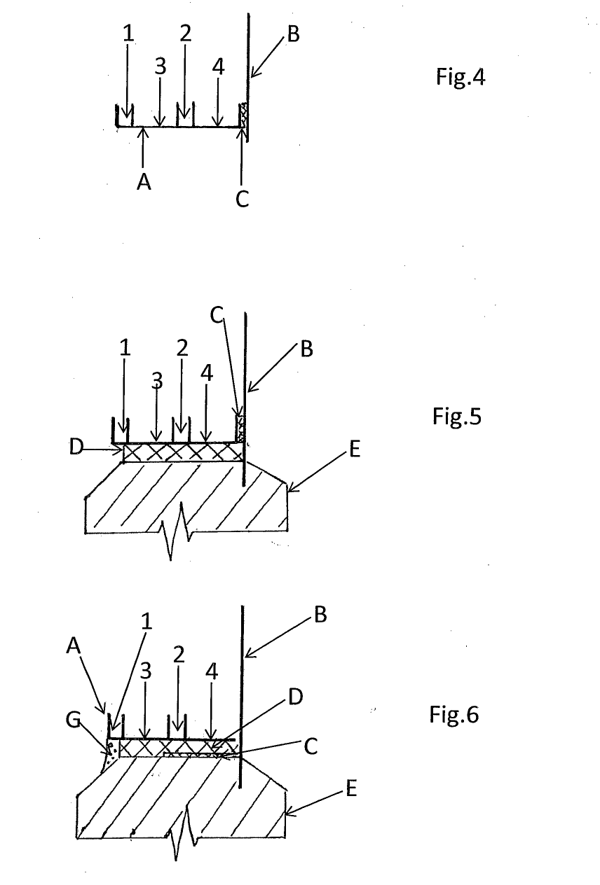

FIG. 4 shows the glazing frame profile configuration A with a method for attachment to the existing pane. The leg 12 is part of the spacer 4, and it has a double-sided mounting tape C attaching it to the existing pane B. Similarly the leg 12 could be mounted onto a parallel face of the existing frame E if desired.

FIG. 5 shows the glazing frame profile configuration A with the addition of an adhesive foam strip D used as an aid for the positioning of the glazing frame A within the existing window frame E.

In FIG. 6, the glazing frame profile configuration A is held in position by the adhesive foam D, the attached mounting tape C and the existing window frame E. Preferably, the foam D presses against the existing pane to give a tidy appearance when viewed from that side, and is suitably wide enough to give the silicone sealant G the correct width to depth ratio indicated by the silicone manufacturer's recommendation.

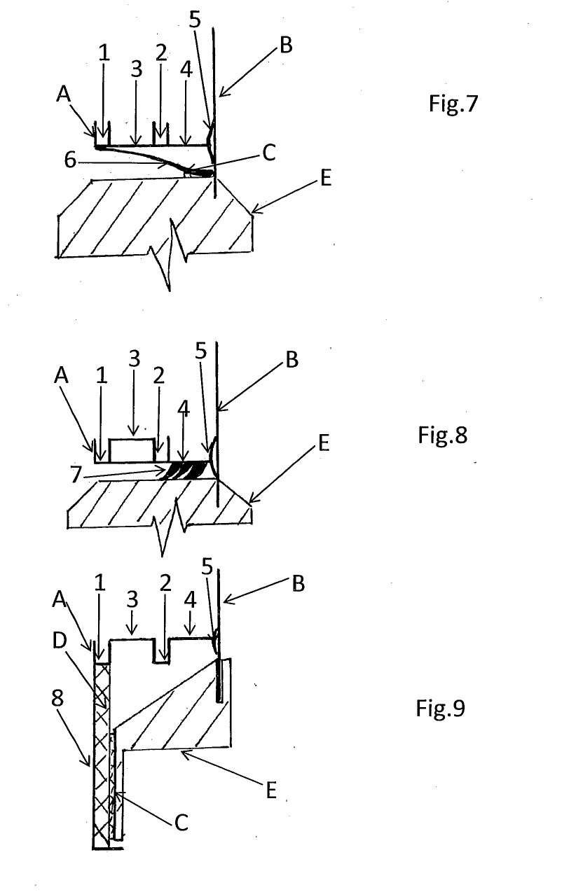

FIG. 7 shows the glazing frame profile configuration A with the addition of a leg 6 that is used as an automatically adjustable mounting system and connected to the existing frame E with a mounting tape C. The glazing frame profile configuration A also has a flexible member 5 as part of the spacer section 4 which presses against the existing pane B to form a seal.

FIG. 8 shows an embodiment wherein the spacer 3 is formed as a box section. Similarly the spacer 4 could have a box section construction. The glazing frame profile configuration A has the addition of flexible fins 7, which constitute an alternative mounting system that enables the glazing frame A to be more easily removed compared to mounting tapes.

Many existing window and door frames are constructed of conductive metal, and have faded appearance. FIG. 9 shows the glazing frame profile configuration A with the addition of an extended leg 8 that covers part of the existing frame E to provide insulation for the existing frame and to enhance the appearance of the window unit. Whilst a single straight leg is shown with a single return leg attached, other combinations of straights, curves and returns are possible within the scope of the various embodiments described herein.

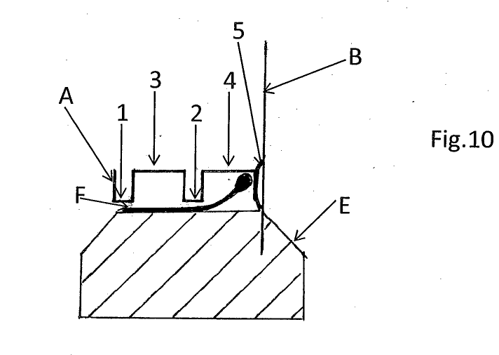

FIG. 10 shows another possible embodiment of the glazing frame profile configuration A, mounted onto a pre-installed section F. Other shapes may be used to mount the glazing frame A onto a pre-installed section within the scope of the embodiments described herein.

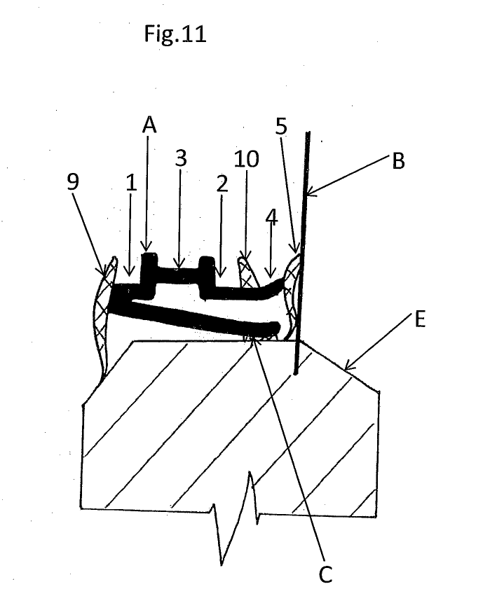

FIG. 11 shows the glazing frame profile configuration A with a flexible member 10 as part of the spacer 4 in order to allow for variation in the thickness of the glazing material. The flexible member 10 ensures the glazing material is pushed against the rigid spacer 3 and a minimum amount of glue is required to achieve a strong joint between the two. The glazing section 1 also borders a flexible section 9, for the same reason as above, and as in the embodiment shown, the flexible section 9 may extend to meet the window frame E to give a tidy finished appearance.

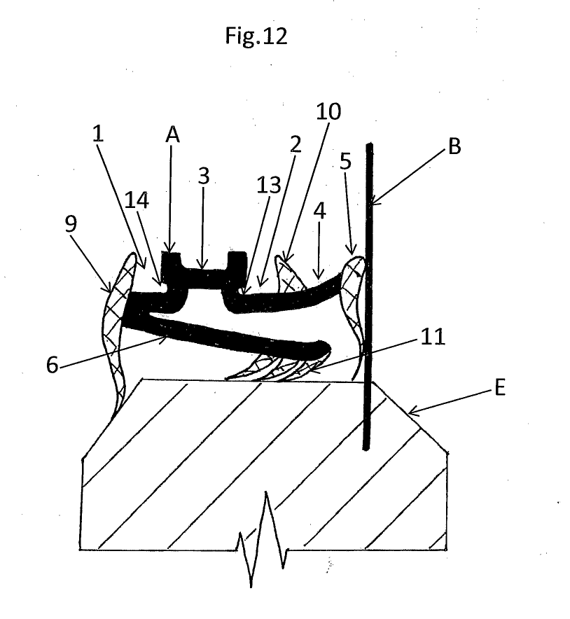

FIG. 12 shows the glazing frame profile configuration A with the additional liquid channels (13,14) in the glazing sections (1,2). The benefit is the ease of gluing the perimeter of the glazing frame A to the glazing material (not shown), without the need to rotate the unit during construction. Where flexible material such as transparent acrylic sheet is used for the glazing, a benefit of binding the sheets to the glazing frame A is a much more rigid overall add-on unit. FIG. 12 also shows how an automatically adjustable leg 6 may have a series of somewhat flexible fins that grip against the existing frame E to hold the glazing frame A in position.

Different combinations of the features described above and shown in the accompanying drawings and other features besides may be used within the scope of the various embodiments described herein.

1. A glazing frame profile configuration comprising two substantially parallel slots or recesses for locating a first and second glazing material respectively therein, a first spacer between the first and second layers of glazing material, and a second spacer located against an exposed face of a pane of the glazing material such that the second spacer is configured to be mounted against an existing window pane, wherein a gas or air filled cavity is created between the two layers of the first and second glazing material and a second gas or air filled cavity is created between the second glazing material and the existing window pane, wherein the glazing profile configuration provides an edge cover to the two layers of glazing material, and includes a flexible material mounted on an outside face of the second spacer, such that the flexible material creates an airtight seal when pressed against the existing window pane.

2. The glazing frame profile configuration as claimed in claim 1, further comprising an adhesive material on an outside face of the second spacer that is substantially parallel to the glazing material, such that the glazing frame profile configuration is attached directly onto the existing window pane by the adhesive material.

3. The glazing frame profile configuration as claimed in claim 2, wherein the adhesive material is a strip of adhesive material configured to create an air tight seal against the existing window pane.

4. The glazing frame profile configuration as claimed in claim 1, further comprising a fixing element for attaching a preinstalled section of the glazing frame configuration onto the existing window pane or an existing frame.

5. The glazing frame profile configuration as claimed in claim 4, wherein a mounting section or a sheet carrying section of the preinstalled section of the glazing frame configuration comprises a flexible material that creates a seal when pressed against the existing window pane or the existing frame.

6. The glazing frame profile configuration as claimed in claim 1, wherein a portion of the glazing frame is manufactured out of a non-transparent and low-thermal conductivity material that extends over an existing window frame, such that one or more faces of the existing window frame are concealed and insulated by the non-transparent and low-thermal conductivity material.

7. The glazing frame profile configuration as claimed in claim 1, wherein the slots or recesses for receiving the glazing material therein include channels for a liquid adhesive to flow between a glazing frame and glazing material such that the glazing frame and glazing material are glued together.

8. The glazing frame profile configuration as claimed in claim 1, wherein one side of a glazing section is manufactured out of a flexible material, such that the glazing material located therein is positioned and retained against a rigid spacer on the opposite side of the glazing section to allow for variation in thickness of the glazing material while minimising the amount of adhesive material required to retain the glazing material into position.

9. The glazing frame profile configuration as claimed in claim 1, further comprising a bendable leg for adjustably retaining the glazing frame profile configuration into position with respect to the existing window frame.

10. The glazing frame profile configuration as claimed in claim 9, wherein the bendable leg includes an adhesive material for securing the glazing frame profile configuration to the existing frame.

11. The glazing frame profile configuration as claimed in claim 9, wherein the bendable leg includes flexible friction fins for adjustably retaining the glazing frame profile configuration into position with respect to the existing window frame.
